(19) United States
(12) Patent Application Publication
(10) Pub. No.: US 2010/0299375 A1
(43) Pub. Date: Nov. 25, 2010

(54) Methods and Devices for Incorporating PDF Files

(75) Inventors: Weilong Tang, Beijing (CN); Zhendong Zhou, Beijing (CN)

Correspondence Address: THE WEBB LAW FIRM, P.C., 700 KOPPERS BUILDING, 436 SEVENTH AVENUE, PITTSBURGH, PA, 15219, US

(73) Assignees: PEKING UNIVERSITY FOUNDER GROUP CO., LTD., Beijing (CN); BEIJING FOUNDER ELECTRONICS CO., LTD., Beijing (CN)

(21) Appl. No.: 12/739,904

(22) PCT Filed: Oct. 24, 2008
(86) PCT No.: PCT/CN2008/072828

§ 371 Date: Aug. 11, 2010

(30) Foreign Application Priority Data
Oct. 24, 2007 (CN) 200710176314.7

(51) Int. Cl. G06F 17/30

(52) U.S. Cl. 707/822; 707/E17.01

(57) ABSTRACT

A method in the field of printing for merging Portable Document Format documents which increases the merging efficiency of said documents. The method comprises: performing upon all priorities, according to a high-to-low priority sequence based on pre-determined priorities for key word type combination, the following processes until all merging pages and merged pages of the documents to be merged are completely determined: acquiring the key word combination corresponding to the key word type combination in the current priority; executing the following process according to each key word combination that is acquired, until all merging pages and merged pages of the documents to be merged are determined, or until processing of all acquired key word combinations is complete. In the remaining documents to file names include documents to be merged under the current key word combination. When it is judged that the selected documents include merging documents and merged documents, merging pages and merged pages are determined; and said merging and merged pages are then merged.

### FIELD OF THE INVENTION

The present invention relates to the prepress technology in the field of press, more particularly, to the methods and devices for incorporating portable document format (PDF) files.

### BACKGROUND OF THE INVENTION

At present, work processes based on PDF are widely used in the field of computer prepress for newspapers, periodicals, books and the like. The processes mainly comprise:

transforming a page description file, such as a PostScript (PS) Language file, usually generated by a typesetting software to a page PDF file (this step is called “standardization”);

processing the standardized PDF file in preflight, trap printing, imposition, making-up and the like;

transforming the processed PDF file to a bitmap file and then transferring the bitmap file to an output device, such as a printer and a typesetter, for outputting.

Generally, both news and advertisements are contained on pages of a newspaper. However, the news and advertisements are in news page description files and advertisement page description files during typesetting, respectively. Thus, the news and advertisements are needed to be incorporated together.

In the prior art, there are two method for incorporating which are described as below.

According to a method, the news page description files and advertisement page description files are manually edited by a professional typesetting worker during typesetting, so as to incorporate the news page description files and advertisement page description files one by one. Then, the generated page description files are standardized to form page PDF files containing both news and advertisements.

According to the other method, the news page description files and advertisement page description files are standardized, respectively. Then, the standardized PDF files are incorporated manually one by one, so as to obtain page PDF files containing both news and advertisements.

The above two method are both implemented manually. Thus, the efficiency of the methods is low. In particular, the efficiency of the methods is very low when there are a large number of files to be processed.

### SUMMARY OF THE INVENTION

The present invention provides methods and devices for incorporating PDF files to improve the efficiency of incorporating PDF files.

The present invention provides a method for incorporating PDF files, comprising: determining incorporating pages and incorporated pages in the PDF files to be incorporated; and incorporating the determined incorporating pages and incorporated pages. The step of determining the incorporating pages and incorporated pages comprises: based on a plurality of predetermined combinations of keyword types and priorities associated with each of the combinations of keyword types, performing the following steps for each of the priorities from the highest priority to the lowest priority until the incorporating pages and incorporated pages of all of the PDF files to be incorporated are determined:

obtaining, according to a combination of keyword types associated with current priority, keyword combinations corresponding to the combination of keyword types;

selecting, according to each of the obtained keyword combinations, PDF files whose file name contains one of the keyword combinations from the remaining PDF files to be incorporated; and

judging whether the selected PDF files include both incorporating files and incorporated files, and if yes, determining the incorporating pages of the incorporating files and the incorporated pages of the incorporated files.

The present invention further provides a device for incorporating PDF files, comprising: a keyword combination obtaining unit configured to obtain, based on predetermined combinations of keyword types and priorities associated with each of the combinations of keyword types from the highest priority to the lowest priority, keyword combinations corresponding to the combination of keyword types in each priority, until incorporating pages and incorporated pages of all of the PDF files to be incorporated are determined; a file selecting unit configured to select PDF files whose file name contains one of current keyword combinations from the remaining PDF files to be incorporated according to each of the keyword combinations obtained by the keyword combination obtaining unit, until the incorporating pages and incorporated pages of all of the PDF files to be incorporated are determined or all of the obtained keyword combinations are processed; a page determining unit configured to determine the incorporating pages of the incorporating files and the incorporated pages of the incorporated files; and an incorporating unit configured to incorporate the incorporating pages and the incorporated pages determined by the page determining unit.

The present invention further provides a method for incorporating PDF files, characterized in that, based on predetermined combinations of keyword types and priorities associated with each of the combinations of keyword types, the following steps are performed for each of the priorities from the highest priority to the lowest priority until all of the PDF files to be incorporated are incorporated:

obtaining, according to a combination of keyword types associated with current priority, keyword combinations corresponding to the combination of keyword types; and

performing the following steps according to each of the obtained keyword combinations, until all of the PDF files to be incorporated are incorporated or all of the obtained keyword combinations are processed:
selecting PDF files whose file name contains one of current keyword combinations from the remaining PDF files to be incorporated; and
judging whether the selected PDF files include both incorporating files and incorporated files, and if yes, incorporating the incorporating files and the incorporated files.

The present invention further provides a device for incorporating PDF files, comprising: a keyword combination obtaining unit configured to obtain, based on predetermined combinations of keyword types and priorities associated with each of the combinations of keyword types from the highest priority to the lowest priority, keyword combinations corresponding to the combination of keyword types in each priority, until all of the PDF files to be incorporated are incorporated; a file selecting unit configured to select PDF files whose file name contains one of current keyword combinations from the remaining PDF files to be incorporated according to each of the keyword combinations obtained by the keyword combination obtaining unit; and a file incorporating unit configured to incorporate the incorporating files and the incorporated files in the selected PDF files to be incorporated.

According to the present invention, the incorporable matching files can be un-missedly and un-repeatedly selected from the PDF files to be incorporated by selecting keywords in the file names of the PDF files to be incorporated to form priority combinations. Then, the matching files are incorporated according to a selected incorporation manner so as to automatically incorporate PDF files, avoid the low efficiency of incorporating manually in the prior art, and improve the efficiency of incorporating standardized PDF files.

### BRIEF DESCRIPTION OF THE DRAWINGS

FIG. 1 is a flow chart of incorporating PDF files automatically according to an example of the present invention;

FIG. 2 shows the configuration of the first kind of device for incorporating PDF files according to an example of the present invention;

FIG. 3 shows the configuration of the page determining unit according to an example of the present invention;

FIG. 4 shows the configuration of the incorporating unit according to an example of the present invention;

FIG. 5 shows the configuration of the incorporating unit according to another example of the present invention; and

FIG. 6 shows the configuration of the second kind of device for incorporating PDF files according to an example of the present invention.

### DESCRIPTION OF THE PREFERRED EMBODIMENTS

To solve the problem stated above, an embodiment of the present invention is to provide solutions in which the news page description file and the advertisement page description file are standardized, respectively, and then the standardized news page PDF file (abbreviated as “news page file”) and the corresponding standardized advertisement page PDF file (abbreviated as “advertisement page file”) are incorporated together automatically.

In the prior art, there is a function (referred as “incorporating function”) capable of incorporating two selected PDF files together such as the CopyAPage Function in the Raster Image Processor (RIP) kernel. Accordingly, the concept of the embodiment of the present invention is to select incorporable matching files in the PDF files to be incorporated (such as the standardized news page file and corresponding advertisement page file), and then repeatedly call the incorporating function according to the incorporating manner so as to incorporate the matching files together.

The file name of a PDF file obtained from the standardization often has the following uniform form: “processor Identity (ID)+main file name+file identity+source file type+serial number. pdf”. The processor ID refers to the serial number of the standardizer which is a program module in a process software. The processor ID differs from one standardizer to another. The main file name is named by the user. Generally, the user will name the PDF files to be incorporated the same main file name. The file identity is used for identifying the type of the PDF file. Generally, for example, the file identity of a news PDF file is “content” and the file identity of an advertisement PDF file is “ad”. The source file type refers to the type of the file before standardization, and generally refers to the type of the page description file, such as PS and the like. The serial number denotes the page number of the PDF file. The files obtained from standardization are single-page files. For example, a PS file having ten pages will be processed to ten PDF files by the same standardizer. The ten PDF files have the same main file name and the same file identity and each of the PDF files includes only one page. The serial numbers of the file names of the standardized PDF files are used for identifying the ten PDF files.

The matching files include incorporating files and incorporated files. Files including not only one or more incorporating files but also one or more incorporated files can be regarded as matching files. That is, the selected files can be considered as matching files, only if the incorporating files and incorporated files are selected from the files to be incorporated. If the news page files are used as incorporating files, the advertisement page files are used as incorporated files; whereas if the advertisement page files are used as incorporating files, the news page files are used as incorporated files.

Based on the uniform form of the file names of the PDF files to be incorporated, the process for implementing the concept will be described as below.

1. Selecting keywords based on the file names of the PDF files to be incorporated, combining the selected keywords, and determining priorities and the keyword combination corresponding to each priority.

Considering the signification of the parts of the file name of a standardized PDF file, the processor ID, main file name and source file type are used as keywords for combination in the present embodiment and the following priorities are determined.

the first priority: “processor ID+main file name+source file type”;

the second priority: “processor ID+main file name”;

the third priority: “main file name+source file type”; and

the fourth priority: “main file name”;

wherein the keyword combination of the second priority can be exchanged with that of the third priority.

The above-mentioned process is to enable the following steps to un-missedly, un-repeatedly and orderly select incorporable PDF matching files for incorporation from the PDF files to be incorporated, based on the determined priorities and the keyword combinations corresponding thereto. Accordingly, all manners of determining priorities which can achieve this purpose are feasible. That is, the determination of the priorities and the keyword combination corresponding to each priority must achieve this purpose. For example, when the PDF files to be incorporated have the same main file name, the priorities also can be determined as follows.

the first priority: “processor ID+source file type”;

the second priority: “processor ID”; and

the third priority: “source file type”.

2. Selecting incorporable matching files from the PDF files to be incorporated based on the determined priorities and the keyword combinations corresponding thereto, and then incorporating the matching files according to the manner of incorporation.

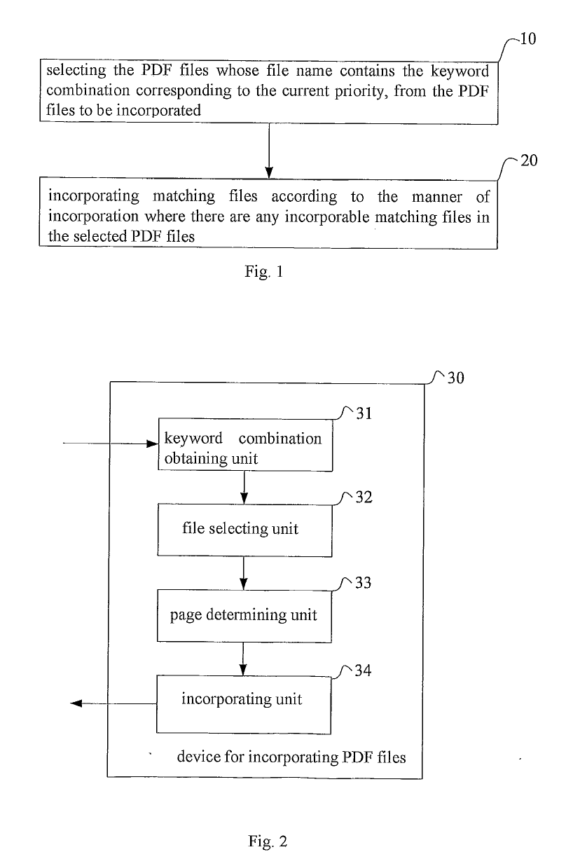

FIG. 1 is a flowchart of automatically incorporating PDF files according to an embodiment of the present invention. As shown in FIG. 1, the process of automatically incorporating PDF files according to the embodiment of the present invention is as follows.

Step 10: selecting the PDF files from the PDF files to be incorporated, whose file name contains the keyword combination corresponding to the current priority.

Step 20: incorporating matching files according to the manner of incorporation where there are any incorporable matching files in the selected PDF files.

It can be known by the following manner whether the selected PDF files include incorporable matching files.

The number of the incorporating files and the number of the incorporated files included in the selected PDF files are computed. If none of the two numbers is equal to 0, the selected PDF files include incorporable matching files. If just one of the two numbers is equal to 0, the process is turned to the next priority. If both of the two numbers is equal to 0, the incorporation for the matching file can be started.

The manner of incorporation refers to the manner for incorporating files based on the number of the incorporating files and the number of the incorporated files included in the incorporable matching files. Examples of the manner of incorporation are as follows.

The first example is to incorporate the first pages. Specifically, the first page of the incorporating file and the first page of the incorporated file are incorporated together. This is suitable for the case where the number of the incorporating files and the number of the incorporated files are larger than or equal to 1.

The second example is to incorporate the corresponding pages. Specifically, the i^{th} page of the incorporating file and the i^{th} page of the incorporated file are incorporated together orderly. This is suitable for the case where both of the number of the incorporating files and the number of the incorporated files are larger than 1. The value of i is in the range of 1 to N, wherein N is equal to the smaller one of the number of the incorporating files and the number of the incorporated files. For example, if the incorporating files include two pages and the incorporated files include three pages, incorporating the corresponding pages means incorporating the first page of the incorporating files with the first page of the incorporated file and incorporating the second page of the incorporating files with the second page of the incorporated file.

The third example is to incorporate all of the pages. This is suitable for the case where just one of the number of the incorporating files and the number of the incorporated files is equal to 1. In this example, the file whose number is equal to 1 is incorporated with all the pages of the other files, respectively.

The above-mentioned manners of incorporation are just illustrative. The above three manners for incorporation are only to flexibly determine the specific pages of the incorporating files and the incorporated files to be incorporated according to the numbers of the incorporating files and incorporated files. Accordingly, there are various manners for incorporation. For example, when both of the number of the incorporating files and the number of the incorporated files are larger than 1, each page of the incorporated files can be configured to be incorporated with the first page of the incorporating files, respectively.

As described above, each PDF file obtained after the standardization for the source file has only one page. Thus, an i^{th} page of the incorporating files or the incorporated files refers to the serial number in the file name of one PDF file instead of the i^{th} page in the PDF file. For example, the second page of the incorporating files refers to the PDF file with a “p0002” serial number in the file name in the incorporating files.

When PDF files are incorporated according to a manner of incorporation, the position of an incorporating file relative to an incorporated file may be needed to be determined.

Two manners for adjusting the relative position are described as below. The first manner comprises two steps of pre-adjustment and further-adjustment. The second manner comprises only one step.

### The First Manner:

Based on the nine-point positioning method, a page of a PDF file is divided into nine position-defining points at top left, middle left, bottom left, top right, middle right, bottom right, top middle, center, and bottom middle. The center of the page of the incorporating file is set as the origin. The direction from center to middle right is set as the direction of X-axis and the direction from center to top middle is set as the direction of Y-axis. Firstly, reference point of each of the incorporating file and the incorporated file is determined, namely, one of the nine position-defining points is selected as the reference point. Preferably, the reference point of the incorporating file is the same as that of the incorporated file. For example, the position-defining point at bottom left of each file is selected as the reference point.

The purpose of setting the reference point is to pre-adjust the relative position between the incorporating file and the incorporated file. For example, if the size of the page of the incorporated file is a half of that of the page of the incorporating file and it is assumed that reference points of the incorporating file and incorporated file coincide with each other, the position-defining point at top left of the incorporated file can be set as the reference point so as to incorporate the incorporated file into the upper half portion of the incorporating file; or the position-defining point at bottom left of the incorporated file can be set as the reference point so as to incorporate the incorporated file into the lower half portion of the incorporating file.

After the relative position between the incorporating file and the incorporated file is pre-adjusted, the coordinate (dx, dy) of the reference point of the incorporated file relative to that of the incorporating file can be determined for further adjusting the relative position in the following manner.

If dx>0, the reference point of the incorporated file is on the right of that of the incorporating file. Otherwise, the reference point of the incorporated file is on the left of that of the incorporating file.

If dy>0, the reference point of the incorporated file is on the top of that of the incorporating file. Otherwise, the reference point of the incorporated file is under that of the incorporating file.

### The Second Manner:

It is assumed that a specified position of each of the incorporating file and the incorporated file is set as the reference point. Preferably, the center of the page of each of the incorporating file and incorporated file is set as the reference point. Then, the coordinate (dx, dy) of the reference point of the incorporated file relative to that of the incorporating file can be determined for directly adjusting the relative position. In the circumstances, the values of dx and dy are usually large.

Only the relative position between the incorporating file and the incorporated file is adjusted with the above process. Furthermore, the angle between the X-axis of the incorporating file and that of the incorporated file can be determined (the angle can be measured by rotating the X-axis of the incorporated file anticlockwise) so that the incorporated file can be rotated to obtain a better effect of incorporation.

In incorporating PDF files based on an incorporation manner, the incorporated regions in the incorporating file and incorporated file may be needed to be determined. The incorporated regions can be determined by determining a cutting region of the incorporating file or incorporated file. The cutting region refers to the remaining region after some portions of the file are cut away.

It is assumed that the whole page of the incorporated file is usually the cutting region. If the cutting region should be repositioned, a rectangle region can be (but not limited) used as the cutting region. The rectangle region can be determined as below.

The coordinate of the bottom left corner on the page of the incorporated file is defined as (0, 0) and then the coordinate of the top right corner of the cutting region is set as (x, y) to determine the rectangle region.

The incorporating function is called to incorporate the cutting region of the incorporated file into the incorporating file. Generally, the incorporating function uses the whole page as the cutting region. That is, the coordinate (x, y) is fixed as the constant coordinate of the top right corner of the incorporated file. Thus, the coordinate (x, y) can be modified as a variable to allow the user to set the value of the coordinate (x, y), so as to adjust the cutting region of the incorporated file.

Hereinafter, the implementation of the above embodiment will be described in detail with reference to some examples.

Assuming that two news pages are to be incorporated with one advertisement page. The detailed implementation is as follows.

Firstly, the news page description file and the advertisement page description file are standardized, respectively, each of which is a PS file. The ID of the processor for processing the news page description file is 400 and the ID of the processor for processing the advertisement page description file is 401. The main file name is named “bjrb”. After the standardization, two news PDF files and one advertisement PDF file each having a single page are obtained, whose file names are 400_bjrb_content_ps_p0001.pdf (the first page of the news content), 400_bjrb_content_ps_p0002.pdf (the second page of the news content) and 401_bjrb_ad_ps_p0001.pdf (the first page of the advertisement content).

TABLE 1

| | | | number of the | number of | |
|---|---|---|---|---|---|
| | key | | advertisement | the news | |
| priority | name | key value | files | files | decision |
| 1 | 400_bjrb_ps | 400_bjrb_content_ps_p0001.pdf | 0 | 2 | use on the second |
| | | 400_bjrb_content_ps_p0002.pdf | | | priority |
| | 401_bjrb_ps | 401_bjrb_ad_ps_p0001.pdf | 1 | 0 | use on the second |
| | | | | | priority |
| 2 | 400_bjrb | 400_bjrb_content_ps_p0001.pdf | 0 | 2 | use on the third |
| | | 400_bjrb_content_ps_p0002.pdf | | | priority |
| | 401_bjrb | 401_bjrb_ad_ps_p0001.pdf | 1 | 0 | use on the third |
| | | | | | priority |
| 3 | bjrb_ps | 400_bjrb_content_ps_p0001.pdf | 1 | 2 | have been matched, |
| | | 400_bjrb_content_ps_p0002.pdf | | | and stored in the file |
| | | 401_bjrb_ad_ps_p0001.pdf | | | list of the pages to be |
| | | | | | incorporated |
| 4 | bjrb | none | 0 | 0 | incorporating the |
| | | | | | PDF files |
| | | | | | corresponding to the |
| | | | | | file list of the pages |
| | | | | | to be incorporated |

Table 1 shows the process of processing the PDF files based on priority according to the example of the present invention. According to Table 1, the process of orderly processing the PDF files based on priority is described in detail as below.

### Processing in the First Priority:

The keyword combination associated with the first priority is “processor ID+main file name+source file type”, which corresponds to two keyword combinations of “400_bjrb_ps” and “401 bjrb_ps”.

Firstly, the PDF files whose file name contains the keyword combination “400_bjrb_ps” are selected from the three PDF files to be incorporated, namely, the PDF files with the file names “400_bjrb_content_ps_p0001.pdf” and “400_bjrb_content_ps_p0002.pdf” are selected.

Then, it is computed according to the file identity that the selected files include two news files without any advertisement file. It can be known that the selected files do not include any incorporable matching file. Thus, the two selected files are not processed in this priority.

Subsequently, the PDF file whose file name contains the keyword combination “401_bjrb_ps” is selected from the three PDF files to be incorporated, namely, the PDF file with the file name “401_bjrb_ad_ps_p0001.pdf” is selected. Then, it is computed according to the file identity that the selected file includes one advertisement file without any news file. It can be known that the selected file does not include any incorporable matching file, either. Thus, the selected file is not processed in this priority.

At this time, the process in the first priority is ended and it turns to the second priority.

### Processing in the Second Priority:

The keyword combination associated with the second priority is “processor ID+main file name”, which corresponds to two keyword combinations of “400_bjrb” and “401_bjrb”. Similar to the process in the first priority, the selected files based on these two keyword combinations do not include any incorporable matching file, either. Thus, it turns to the third priority.

### Processing in the Third Priority:

The keyword combination associated with the third priority is “main file name+source file type”, which corresponds to one keyword combination of “bjrb_ps”. The PDF files whose file name contains the keyword combination “bjrb_ps” are selected from the three PDF files to be incorporated, namely, the PDF files with the file names “400_bjrb_content_ps_p0001.pdf”, “400_bjrb content_ps_p0002.pdf” and “401_bjrb_ad_ps_p0001.pdf” are selected. Then, it is computed according to the file identity that the selected files include two news files and one advertisement file. It can be known that the selected files include incorporable matching files. Then, a user interface is generated, in which manners of incorporating the matching files are displayed. The user can select a suitable incorporation manner via the user interface. Alternatively, the incorporation manner also can be pre-selected. That is, the user interface may be generated before the process in priority or before the standardization so that the user can select a incorporation manner.

It is assumed that the user selects such an incorporation manner that all of the pages are to be incorporated. According to the above description of incorporation manners, since there are two news files and one advertisement file, “incorporating all of the pages” means incorporating the page of the advertisement file with each of the pages of the news files, namely, incorporating the file with the file name “400_bjrb_content_ps_p0001.pdf” with the file with the file name “401_bjrb_ad_ps_p0001.pdf” and incorporating the file with the file name “400_bjrb_content_ps_p0002.pdf” with the file with the file name “401_bjrb_ad_ps_p0001.pdf”.

Then, the storing paths of the above PDF files to be incorporated are added to a list of files to be incorporated, respectively. Table 2 is a list of files to be incorporated according to an example of the present invention. It can be seen from Table 2 that the storing paths of the PDF files “400_bjrb content_ps_p0001.pdf”, “401_bjrb_ad_ps_p0001.pdf”, “400_bjrb_content_ps_p0002.pdf” and “401_bjrb_ad_ps_p0001.pdf” are added to the first, second, third and fourth rows, respectively. Then, it turns to the next priority.

TABLE 2

| | |
|---|---|
| 1 | the storing path of the PDF file “400_bjrb_content_ps_p0001.pdf” |
| 2 | the storing path of the PDF file “401_bjrb_ad_ps_p0001.pdf” |
| 3 | the storing path of the PDF file “400_bjrb_content_ps_p0002.pdf” |
| 4 | the storing path of the PDF file “401_bjrb_ad_ps_p0001.pdf” |

Alternatively, another implementation of the above process is described as below.

It is also assumed that the user selects the incorporation manner in which all of the pages are to be incorporated. According to the above description of the incorporation manners, since there are two news files and one advertisement file, it can be firstly determined that the PDF file “400_bjrb content_ps_p0001.pdf” should be incorporated with the PDF file “401_bjrb_ad_ps_p0001.pdf”. Then, the incorporating function is called to incorporate these two PDF files, instead of storing the storing paths of these two PDF files in the list of files to be incorporated. Subsequently, it can be determined that the PDF file “400_bjrb_content_ps_p0002.pdf” should be incorporated with the PDF file “401_bjrb_ad_ps_p0001.pdf” and the incorporating function is called to incorporate these two PDF files. And then, it turns to the next priority. According to this implementation, the incorporation process may be carried out without needing to build up the list of files to be incorporated.

### Processing in the Fourth Priority:

The keyword combination associated with the fourth priority is “main file name”, which corresponds to one keyword combination of “bjrb”. Since all of the files to be incorporated have been selected, there are no incorporating files and incorporated files. Accordingly, the incorporating function is called to incorporate the files in the list of files to be incorporated.

Firstly, the files indexed by the paths in the first and second rows of the list are incorporated together.

Secondly, the files indexed by the paths in the third and fourth rows of the list are incorporated together.

If the above alternative implementation is utilized in which the list is not needed to be built up, since the incorporating function has been called in the third priority to incorporate the matching files, the process can be ended in the case that the number of the incorporating files and the number of the incorporated files are both computed as 0.

According to the above method for incorporating PDF files, since the files to be incorporated are incorporated automatically based on the priority, the problems such as time-consuming, cost-consuming and low-efficiency in manually incorporating the standardized PDF files in the prior art are solved, the efficiency of incorporating the PDF files are increased, the prepress process is speeded up, and the labor cost is saved.

If the relative position needs to be adjusted or a portion needs to be cut, when the incorporating function is called to incorporate the matching files, the relative position can be determined or the portion can be cut according to the processes stated above so as to flexibly incorporate the PDF files to obtain a good effect of incorporating, satisfy various requirements of a specific user. For example, if an advertisement is located in the lower half portion on the page of the PDF file “401_bjrb_content_ps_p0001.pdf” and needs to be arranged on the upper half portion of the incorporated file after the PDF file “400_bjrb_content_ps_p0001.pdf” is incorporated with the PDF file “401_bjrb_ad_ps_p0001.pdf”, the value of dy can be set as a suitable positive number so that the advertisement is incorporated in the upper half portion of the incorporated file.

In addition to the method of incorporating described with reference to the above embodiments, the present invention also provides two kinds of devices for incorporating PDF files.

FIG. 2 shows the configuration of the first kind of device for incorporating PDF files according to an example of the present invention. As shown in FIG. 2, the first kind of device 30 for incorporating PDF files comprises a keyword combination obtaining unit 31, a file selecting unit 32, a page determining unit 33 and an incorporating unit 34.

The keyword combination obtaining unit 31 is configured to obtain the keyword combinations corresponding to the pre-determined combination of keyword types associated with each priority based on the combinations of keyword types and the priorities corresponding to each combination of keyword types according to the order of the priorities, until the incorporating pages and incorporated pages of all of the PDF files to be incorporated are determined.

The file selecting unit 32 is configured to select the PDF files whose file name contains the current keyword combination from the remaining PDF files to be incorporated according to each of the keyword combinations obtained by the keyword combination obtaining unit 31, until the incorporating pages and incorporated pages of all of the PDF files to be incorporated are determined or all of the obtained keyword combinations are processed.

The page determining unit 33 is configured to determine the incorporating pages of the incorporating files and the incorporated pages of the incorporated files when it is judged that the PDF files selected by the file selecting unit 32 include incorporating files and incorporated files.

The incorporating unit 34 is configured to incorporate the incorporating pages and the incorporated pages determined by the page determining unit 33.

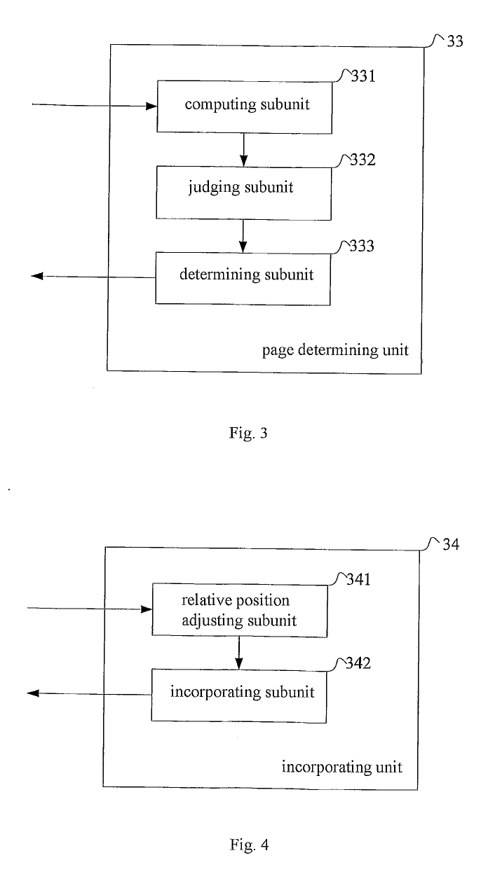

FIG. 3 shows the configuration of the page determining unit according to an example of the present invention. As shown in FIG. 3, the page determining unit 33 may comprises a computing subunit 331, a judging subunit 332 and a determining subunit 333.

The computing subunit 331 is configured to compute the number of the incorporating files and the number of the incorporated files included in the selected PDF files to be incorporated.

The judging subunit 332 is configured to judge whether none of the number of the incorporating files and the number of the incorporated files is equal to 0 and to conclude that the selected PDF files to be incorporated include incorporating files and incorporated files where none of the numbers is equal to 0.

The determining subunit 333 is configured to determine the incorporating pages of the incorporating files and the incorporated pages of the incorporated files when the judging subunit judges that the selected PDF files to be incorporated include incorporating files and incorporated files.

FIG. 4 shows the con figuration of the incorporating unit according to an example of the present invention. As shown in FIG. 4, if it is necessary to adjust the relative position between the PDF files to be incorporated during incorporating the PDF files to be incorporated, the incorporating unit 34 may comprise a relative position adjusting subunit 341 and an incorporating subunit 342.

The relative position adjusting subunit 341 is configured to adjust the relative position between an incorporating page and an incorporated page.

The incorporating subunit 342 is configured to incorporate the incorporating page and the incorporated page based on the relative position adjusted by the relative position adjusting subunit.

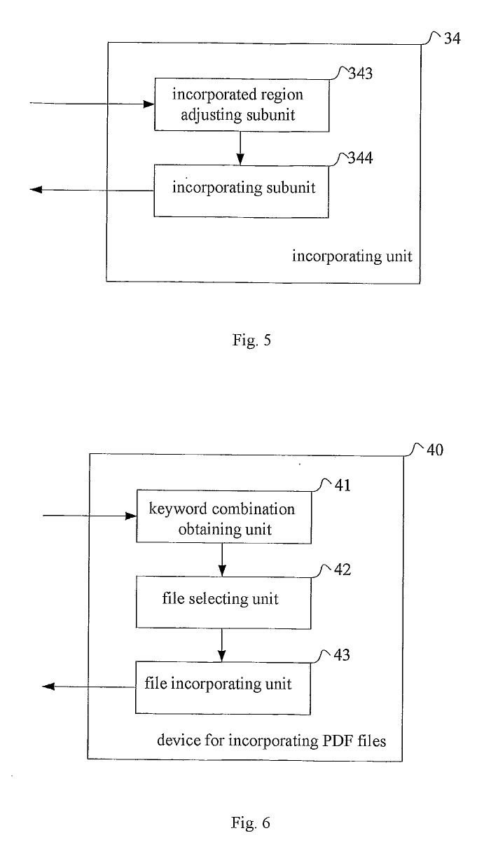

FIG. 5 shows the configuration of the incorporating unit according to another example of the present invention. As shown in FIG. 5, if it is necessary to adjust the incorporated regions of the incorporating files and the incorporated files during incorporating the PDF files to be incorporated, the incorporating unit 34 may comprise an incorporated region adjusting subunit 343 and an incorporating subunit 344.

The incorporated region adjusting subunit 343 is configured to adjust the incorporated regions of an incorporating page and an incorporated page.

The incorporating subunit 344 is configured to incorporate the incorporating page and the incorporated page based on the incorporated regions adjusted by the incorporated region adjusting subunit.

For the method of incorporating PDF files in each priority level according to the above embodiments, the present invention also provides the second kind of device for incorporating PDF files.

FIG. 6 shows the configuration of the second kind of device for incorporating PDF files according to an example of the present invention. As shown in FIG. 6, the second kind of device 40 for incorporating PDF files comprises a keyword combination obtaining unit 41, a file selecting unit 42 and a file incorporating unit 43.

The keyword combination obtaining unit 41 is configured to obtain the keyword combinations corresponding to the pre-determined combination of keyword types associated with the current priority based on the combination of keyword types and the priority corresponding to each combination of keyword types according to the order of the priorities, until all of the PDF files to be incorporated are incorporated.

The file selecting unit 42 is configured to select the PDF files whose file name contains the current keyword combination from the remaining PDF files to be incorporated according to each of the keyword combinations obtained by the keyword combination obtaining unit 31, until all of the PDF files to be incorporated are incorporated or all of the keyword combinations obtained by the keyword combination obtaining unit are processed.

The file incorporating unit 43 is configured to incorporate the incorporating files and the incorporated files when it is judged that the PDF files selected by the file selecting unit 42 include incorporating files and incorporated files.

The present invention is not limited to the descriptions and embodiments mentioned above. Variations and modification made by those skilled in the art according to the disclosure herein should be within the scope of the present invention.

1. A method for incorporating PDF files, comprising:
determining incorporating pages and incorporated pages in the PDF files to be incorporated; and
incorporating the determined incorporating pages and incorporated pages,
wherein the step of determining the incorporating pages and incorporated pages comprises:
performing the following steps for each of the priorities from the highest priority to the lowest priority based on a plurality of predetermined combinations of keyword types and priorities associated with the combinations of keyword types, until the incorporating pages and incorporated pages of all of the PDF files to be incorporated are determined:
obtaining, according to a combination of keyword types associated with a current priority, keyword combinations corresponding to the combination of keyword types;
selecting, according to each of the obtained keyword combinations, PDF files whose file name contains one of the keyword combinations from the remaining PDF files to be incorporated; and
judging whether the selected PDF files include both incorporating files and incorporated files, and if yes, determining the incorporating pages of the incorporating files and the incorporated pages of the incorporated files.

2. The method according to claim 1, wherein the step of judging whether the selected PDF files to be incorporated include both incorporating files and incorporated files further comprises:
computing the number of the incorporating files and the number of the incorporated files included in the selected PDF files;
judging whether none of the number of the incorporating files and the number of the incorporated files is equal to 0; and
concluding that the selected PDF files include the incorporating files and incorporated files where none of the numbers is equal to 0.

3. The method according to claim 1, wherein the following steps are performed to judge whether the step of determining the incorporating pages and incorporated pages has been accomplished on all of the PDF files to be incorporated:
computing the number of the incorporating files and the number of the incorporated files included in the selected PDF files;
judging whether both the number of the incorporating files and the number of the incorporated files are equal to 0; and
confirming that the incorporating pages and incorporated pages in all of the PDF files to be incorporated have been determined where both of the numbers are equal to 0.

4. The method according to claim 1, wherein the step of determining the incorporating pages and the incorporated pages in the PDF files to be incorporated is performed in a predetermined incorporation manner.

5. The method according to claim 1, wherein the step of determining the incorporating pages and the incorporated pages comprises:
generating a user interface for displaying various incorporation manners;
obtaining an incorporation manner selected on the user interface by a user; and
determining the incorporating pages and the incorporated pages in the PDF files to be incorporated based on the incorporation manner selected by the user.

6. The method according to claim 4, wherein the incorporation manners comprise:
incorporating a first page of the incorporating file with a first page of the incorporated file;
incorporating a first page of the incorporating file with each page of the incorporated file; and
incorporating pages having the same page number in the incorporating file and the incorporated file together.

7. The method according to claim 1, further comprising:
adjusting a relative position between the incorporating page and the incorporated page.

8. The method according to claim 7, wherein the step of adjusting comprises:
generating a display of a reference point of the incorporating page and a reference point of the incorporated page and a user interface for the coordinate of the reference point of the incorporated page relative to the reference point of the incorporating page;
obtaining the two reference points selected on the user interface by a user and the coordinate determined by the user; and
adjusting the relative position between the incorporating page and the incorporated page during the incorporating page and incorporated page are incorporated together according to the obtained reference points and coordinate.

9. The method according to claim 1, further comprising:
adjusting incorporated regions of the incorporating page and the incorporated page.

10. A device for incorporating PDF files, comprising:
a keyword combination obtaining unit configured to obtain, based on predetermined combinations of keyword types and priorities associated with the combinations of keyword types, keyword combinations corresponding to the combination of keyword types in each priority from the highest priority to the lowest priority, until incorporating pages and incorporated pages of all of the PDF files to be incorporated are determined;
a file selecting unit configured to select PDF files whose file name contains one of current keyword combinations from the remaining PDF files to be incorporated according to each of the keyword combinations obtained by the keyword combination obtaining unit, until the incorporating pages and incorporated pages of all of the PDF files to be incorporated are determined or all of the obtained keyword combinations are processed;
a page determining unit configured to determine the incorporating pages of the incorporating files and the incorporated pages of the incorporated files; and
an incorporating unit configured to incorporate the incorporating pages and the incorporated pages determined by the page determining unit.

11. The device according to claim 10, wherein the page determining unit comprises:
a computing subunit configured to compute the number of the incorporating files and the number of the incorporated files included in the selected PDF files to be incorporated;
a judging subunit configured to judge whether none of the number of the incorporating files and the number of the incorporated files is equal to 0 and to conclude that the selected PDF files to be incorporated include incorporating files and incorporated files where none of the numbers is equal to 0; and
a determining subunit configured to determine the incorporating pages of the incorporating files and the incorporated pages of the incorporated files when the judging subunit judges that the selected PDF files to be incorporated include incorporating files and incorporated files.

12. The device according to claim 10, wherein the incorporating unit comprises:
a relative position adjusting subunit configured to adjust a relative position between an incorporating page and an incorporated page; and
an incorporating subunit configured to incorporate the incorporating page and the incorporated page according to the relative position adjusted by the relative position adjusting subunit.

13. The device according to claim 10, wherein the incorporating unit comprises:
an incorporated region adjusting subunit configured to adjust incorporated regions of an incorporating page and an incorporated page; and
an incorporating subunit configured to incorporate the incorporating page and the incorporated page according to the incorporated regions adjusted by the incorporated region adjusting subunit.

14. A method for incorporating PDF files, based on predetermined combinations of keyword types and priorities associated with the combinations of keyword types, comprising the following steps are performed for each of the priorities from the highest priority to the lowest priority, until all of the PDF files to be incorporated are incorporated:
obtaining, according to a combination of keyword types associated with a current priority, keyword combinations corresponding to the combination of keyword types; and
performing the following steps according to each of the obtained keyword combinations, until all of the PDF files to be incorporated are incorporated or all of the obtained keyword combinations are processed:
selecting PDF files whose file name contains one of current keyword combinations from the remaining PDF files to be incorporated; and
judging whether the selected PDF files include both incorporating files and incorporated files, and if yes, incorporating the incorporating files and the incorporated files.

15. A device for incorporating PDF files, comprising:
a keyword combination obtaining unit configured to obtain, based on predetermined combinations of keyword types and priorities associated with the combinations of keyword types, keyword combinations corresponding to the combination of keyword types in each priority from the highest priority to the lowest priority, until all of the PDF files to be incorporated are incorporated;
a file selecting unit configured to select PDF files whose file name contains one of current keyword combinations from the remaining PDF files to be incorporated according to each of the keyword combinations obtained by the keyword combination obtaining unit; and
a file incorporating unit configured to incorporate the incorporating files and the incorporated files in the selected PDF files to be incorporated.

16. The device according to claim 15, further comprising:
a judging subunit configured to judge whether none of the number of the incorporating files and the number of the incorporated files is equal to 0, wherein if none of the numbers is equal to 0, the file incorporating unit incorporates the incorporating files and the incorporated files.

17. The method according to claim 5, wherein the incorporation manners comprise:
incorporating a first page of the incorporating file with a first page of the incorporated file;
incorporating a first page of the incorporating file with each page of the incorporated file; and
incorporating pages having the same page number in the incorporating file and the incorporated file together.

18. The device according to claim 11, wherein the incorporating unit comprises:
a relative position adjusting subunit configured to adjust a relative position between an incorporating page and an incorporated page; and
an incorporating subunit configured to incorporate the incorporating page and the incorporated page according to the relative position adjusted by the relative position adjusting subunit.

19. The device according to claim 11, wherein the incorporating unit comprises:
an incorporated region adjusting subunit configured to adjust incorporated regions of an incorporating page and an incorporated page; and
an incorporating subunit configured to incorporate the incorporating page and the incorporated page according to the incorporated regions adjusted by the incorporated region adjusting subunit.
